(19) United States
(12) Patent Application Publication
(10) Pub. No.: US 2006/0149725 A1
(43) Pub. Date: Jul. 6, 2006

(54) Managing electronic documents

(76) Inventor: Gerd M. Ritter, Heidelberg (DE)

Correspondence Address: FISH & RICHARDSON, P.C., PO BOX 1022, MINNEAPOLIS, MN, 55440-1022, US

(21) Appl. No.: 11/027,178

(22) Filed: Jan. 3, 2005

(51) Int. Cl. G06F 17/30

(52) U.S. Cl. 707/5

(57) ABSTRACT

A method of reducing a user's work load relating to administrating an electronic document includes displaying an electronic document to a user in a computer system, and receiving an input from the user, the input specifying a future time when a predefined action is to be automatically taken with regard to the electronic document. The specified future time is recorded in the computer system for automatically taking the predefined action with regard to the electronic document. The predefined action may involve deleting, archiving, or changing a status or classification of the electronic document. There may be specified a condition for taking the predefined action at the specified future time.

### TECHNICAL FIELD

This description relates to performing a predefined action in managing an electronic document.

### BACKGROUND

Most computer systems use documents in electronic format. For example, many software application programs can generate and display one or more electronic documents to users. Documents may contain business or private information, and may, to mention just a few examples, include text, numbers, figures, attachments and other information. Electronic documents may be displayed to a user in a graphical user interface (GUI).

With computerized access to electronic documents typically follows a desire or need to manage the documents properly. Managing documents may involve administrating, processing, moving, and deleting the documents, to name a few examples. For example, electronic documents may become obsolete or inaccurate as time goes by and should therefore be sorted out of the system or archived. As another example, a user that is working on an electronic document may wish to wait for more information or await the outcome of an unknown event.

These are examples of foreseeable yet hard-to-quantify future developments. It may be difficult, however, to foresee exactly when a document will become obsolete or how long it will take before the additional information becomes available, but the user may be in the best position to do so. Moreover, it may be easiest to make these decisions while the user is working on the document in the computer system, because the user then may be aware of the entire business context of the document.

Existing systems may provide some form of document management. For example, a system for processing sales orders may be configured to detect backordered products by comparing a scheduled delivery date with the current date. The system may then take a specific action that relates to the backordered product. Another example is that a system setting triggers archiving of a sales order. These functions are rule based, meaning that the system executes a predefined rule to determine whether and when to undertake the specific action. One disadvantage with rule-based features is that it can be difficult or impossible for a user, typically an administrator, to foresee and formulate rules that adequately take into account a complex business context, which many documents have. Moreover, a rule that works for one user or in one business context may not work well for another user or in another context.

In the absence of a rule-based document administration process, the user may have to manually look at old documents and decide what to do with them. This, in turn, forces the user to recall the business context of each document, which can be difficult and time-consuming, particularly if it has been a long time since the user worked with the document. Accordingly, managing an electronic document may be a considerable work load for a user.

### SUMMARY

The invention relates to performing a predefined action in managing an electronic document.

In a first general aspect, a method of reducing a user's work load relating to managing an electronic document comprises displaying an electronic document to a user in a computer system, receiving an input from the user, the input specifying a future time when a predefined action is to be automatically taken with regard to the electronic document, and recording the specified future time in the computer system for automatically taking the predefined action with regard to the electronic document.

In selected embodiments, the input is received upon the user placing the electronic document in a folder that is associated with the future time. The predefined action also may be associated with the folder.

In selected embodiments, the input is received upon the user selecting an input control for creating the electronic document, the input control being associated with the future time. There may be several alternative input controls for initiating the creation of the electronic document, each of the several input controls being associated with a different future time, and upon user selection of one of the several alternative input controls the future time associated with the selected input control may be recorded for automatically taking the predefined action with regard to the electronic document. The predefined action also may be associated with the folder.

In selected embodiments, the predefined action to be automatically taken with regard to the electronic document may be one selected from the group consisting of: relocating, deleting, archiving, changing status, changing classification, initiating a workflow with regard to the electronic document, and combinations thereof.

Advantages of the systems and techniques described herein may include any or all of the following: Providing an improved management of electronic documents; providing a reduced work load in deciding future administrative actions with regard to documents; and providing convenient scheduling of document-related tasks.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of a computer system that manages electronic documents;

FIGS. 2 and 3 are examples of GUIs that the system shown in FIG. 1 can generate;

FIG. 4 is an example of documents stored in the system shown in FIG. 1;

FIG. 5 is another example of a GUI that the system shown in FIG. 1 can generate;

FIG. 6 is an example of documents stored in the system shown in FIG. 1;

FIG. 7 is an embodiment of an inventive method; and

FIG. 8 is a block diagram of a general computer system.

Like reference numerals in the various drawings indicate like elements.

### DETAILED DESCRIPTION

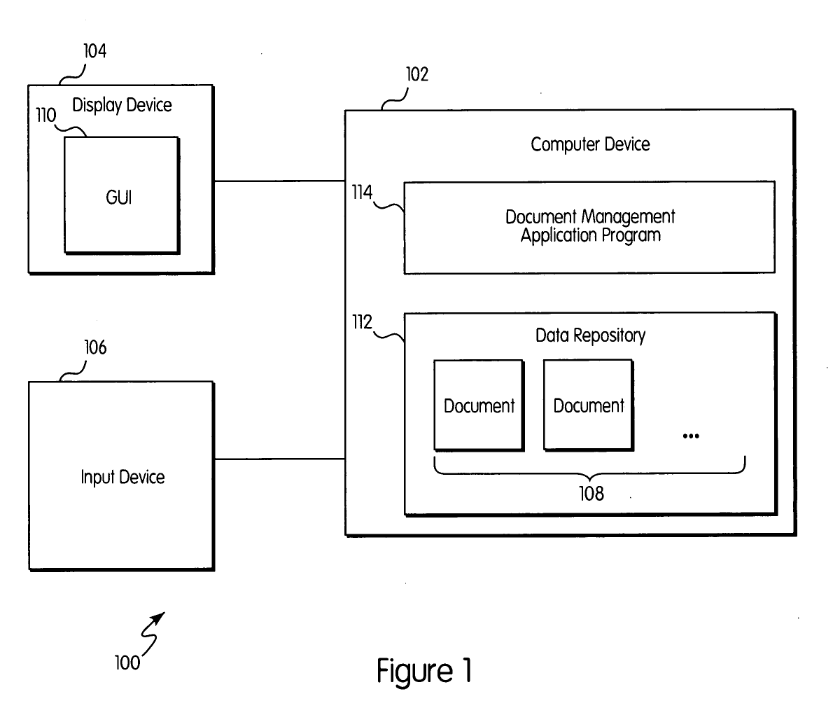

FIG. 1 is a block diagram of a computer system 100 that includes a computer device 102, a display device 104 and an input device 106, for example a mouse or a keyboard. The system includes one or more electronic documents 108 that can be displayed to the user in a GUI 110 generated on the display device. In this example, the documents are stored in a data repository 112 on the computer device. For clarity, only a few documents 108 are shown, and they are stored in the same data repository. In other situations, there may be a large number of documents stored in several repositories.

The system 100 includes at least one document management application program 114. The program 114 may be capable of rendering viewable images of the documents 108 for display in the GUI 110. That is, the user may initiate the program 114 so that the user can review or edit one or more of the documents.

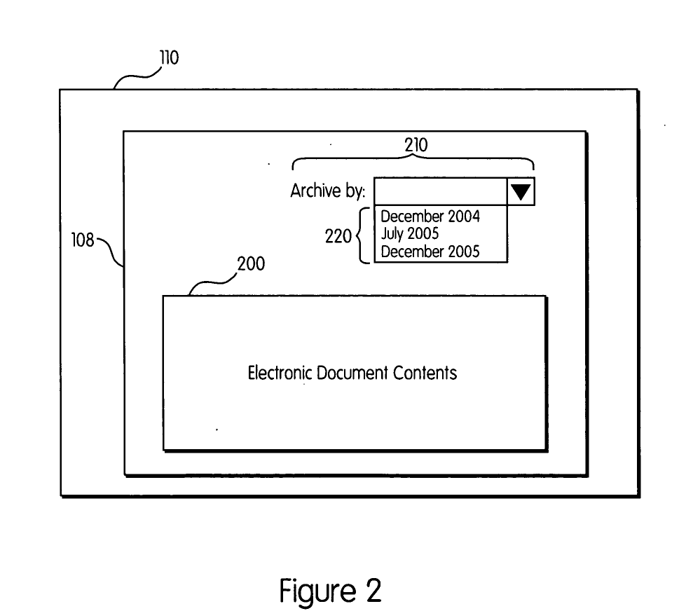

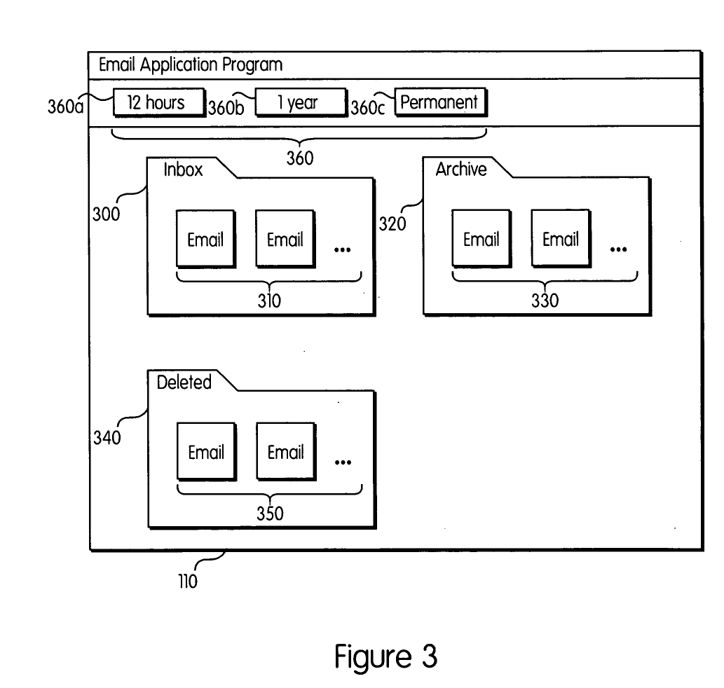

While any of the documents 108 is being displayed, the user can make an input with the input device 106 to specify how the document should be administrated. For example, the input specifies a future time when a predefined action is to be automatically taken with regard to the document. The computer device 102 records the specified future time for automatically taking the predefined action. Some examples of how the user can make the input will be described with reference to FIGS. 2 and 3.

FIG. 2 shows an example of how the GUI 110 can appear while a view of an arbitrary electronic document 108 is being displayed therein. The document 108 is schematically illustrated as having electronic document contents 200. For example, the document 108 was created at some earlier time and the user has initiated the document management application program 114 to review or modify the contents 200.

An input control 210 is displayed in association with the document 108. Here, the input control is displayed on top of the document. The input control lets the user specify that a predefined action should be taken with regard to the document 108 at a particular future time. Here, the predefined action involves archiving the document 108, and the input control provides alternative user-selectable inputs 220 for archiving the document by December 2004, July 2005 and December 2005, respectively. The user, who currently knows the business context of the document 108, can select one of the proposed future times that is appropriate for this particular document, or can enter an arbitrary time in the input field. Thus, the control 210 lets the user select, at a moment when the user is familiar with the document's business context, a time for automatically archiving the document. This means that later, when the user has perhaps forgotten the business context, the user need not decide whether to delete the document. Other embodiments may involve the same or a different action performed with regard to this or another document, for example deletion of an email or archiving of a sales order.

FIG. 3 shows another example of how the GUI 110 can appear. Here, the document management application program 114 includes an email application program that generates content for display in the GUI. The email application program includes an inbox folder 300 that contains one or more received emails 310. The email application program includes an archive folder 300 that contains one or more archived emails 330. The email application program includes a deleted items folder 340 that contains one or more deleted emails 350.

In this example, any and all of the emails 310, 330 and 350 are electronic documents. When the user opens one of these emails in the GUI 110, the input control 210 (see FIG. 2) may also be displayed in association therewith, such that the user can enter a future time for automatically taking a predefined action. For example, the predefined action may involve deleting the email (placing it in the folder 340) or archiving it (placing it in the folder 320). In some implementations, emails can be archived without being placed in the specific folder 320.

The GUI 110 may also provide that the user can select the future time upon causing the system to create a new email. The GUI 110 may include one or more user-selectable input controls 360 that trigger display of a new (blank or reply) email in the GUI 110. Any or all of such controls 360 may be associated with a particular future time for automatically taking a specific action. For example, a first input control 360A creates a new email that will be deleted from the recipient's inbox in twelve hours (for example by the recipient's inbox also being serviced by the program 114 in a network). Similarly, a second input control 360B creates a new email that will be deleted from the recipient's inbox in one year. A third input control 360C, in contrast, creates a new email that will not automatically be deleted at any future time. The third input control is labeled “Permanent” to distinguish it from the functions of the first and second input controls, and it will be understood that an email created using this control can be manually deleted as is commonly known. Accordingly, activating any of the controls 360 may cause a specified future time to be recorded in association with the created email.

For example, the user chooses the first input control 360A for emails that will soon be obsolete, and the second input control 360B (or alternatively the third input control 360C) for emails that will remain relevant for a longer time. Accordingly, the input control(s) 360 may provide a convenient way for the user to choose when the new email should be deleted.

In another implementation, the input control(s) 360 may relate to another predefined action, such as archiving the new email. Other predefined actions may be used, such as automatically resubmitting the email if the recipient did not open it, or send a reply, before a specified day.

It is noted that the user may specify a document-specific predefined action, such as in the examples above, also when there exists a generally applicable rule for the predefined action. For example, there may exist a default rule in the email program specifying that the emails 310 in the inbox folder 300 are to be archived after six months. Moreover, the GUI may include input controls associated with different predefined actions, such as separate input controls 360 regarding deletion and archiving, respectively, of the email. As another example, the predefined action may be selected among several alternative actions, similarly to how the different alternative future times are listed in the input control 210.

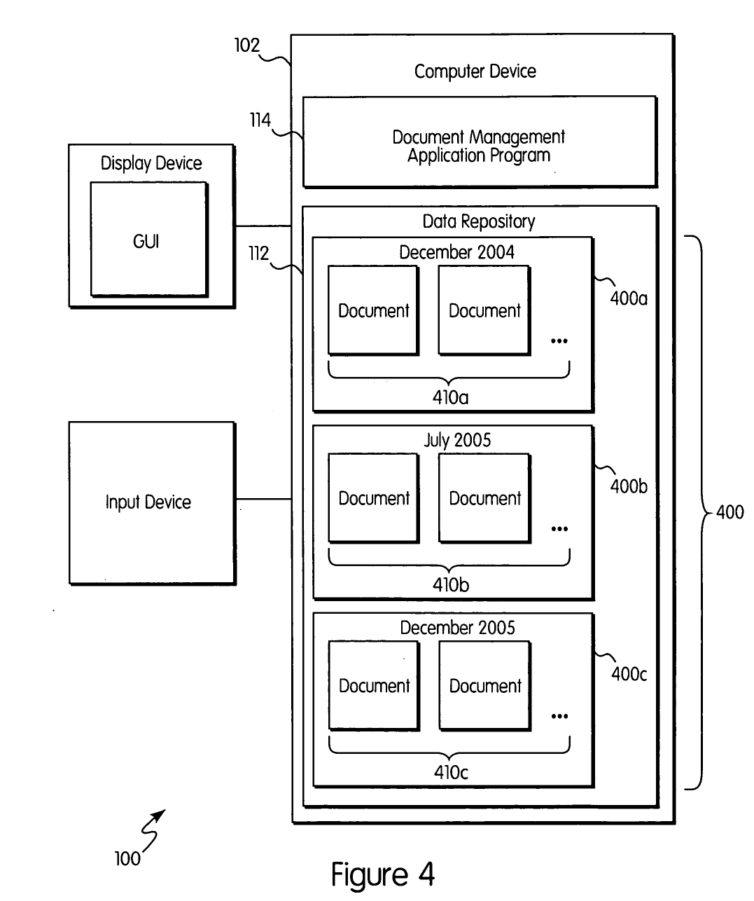

FIG. 4 shows that the data repository 112 can include one or more folders 400 that are associated with taking a certain predefined action at a particular future time, with regard to the folder's contents. The user can place an electronic document in one of the folders 400 to have the system 100 automatically perform the predefined action with regard to that document at the specified future time. For example, the predefined action may involve deleting the document and there may exist a first folder 400A for deletion by December 2004, a second folder 400B for deletion by July 2005 and a third folder 400C for deletion by December 2005. The user can place documents in any of the respective folders, such as one or more documents 410A in the first folder, one or more documents 410B in the second folder and one or more documents 410C in the third folder. Placing each document corresponds to the input specifying the future time for that document. For example, an email program can include the folders 400 and the user can drop received emails in the folder(s) for convenient automated processing.

The future times may be specified in different ways. For example, a future time may be specified as a fix future time, such as the time “December 2004” specified in the input control 210 and in the first folder 400A. A specific future time may be measured from a time of receiving the input, such as “in 30 days.” A specific future time may be measured from a time of creating the electronic document, such as the twelve-hour time specified in the first input control 360A. As another example, the specific future time may be measured from a specified event in the computer system. Combinations of these ways may be used. Any specified future time may include a date.

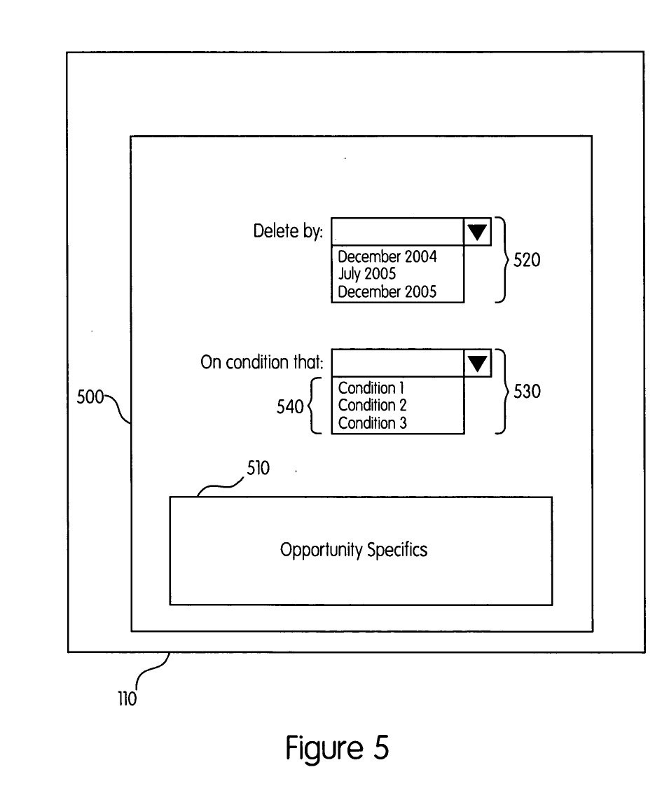

FIG. 5 shows another example of how the GUI 110 can appear. Here, an opportunity document 500 is being displayed in the GUI. A business organization may use opportunity documents (sometimes called “lead documents”) to track business opportunities such as possible sales or potential customers. That is, a member of the organization who learns of a business opportunity may record the relevant details in an opportunity record for possible follow-up later. Here, this information is schematically illustrated as opportunity specifics 510 in the opportunity document.

While the user is working on the opportunity document and therefore has it open in the system 100, the user may have an understanding of how long this opportunity will remain valid and relevant. This may relate to a business context inside or outside the organization, or both. For example, when the opportunity relates to a possible sales order, the user may know that the prospective customer intends to close the transaction with some vendor within a month. Accordingly, unless the user in the meantime learns that the sales opportunity will exist for a longer time, it may be desired to change the status of the opportunity document after that time frame. For example, the status of the opportunity document changes to “lost” when nothing materializes within the month. As another example, the opportunity document can be automatically forwarded to a more experienced representative.

A first input control 520 is displayed in association with the document 500. The first input control lets the user input a future time for automatically taking a predefined action with regard to the opportunity document; here, the action involves deleting the document. The first input control lists some examples of future times that can be used.

A second input control 530 is also displayed in association with the document 500. The second input control lets the user input a condition for automatically taking the predefined action with regard to the document at the specified future time. That is, if the condition is satisfied, the predefined action will be automatically taken with regard to the opportunity document at the specified future time. The second input control here includes Conditions 1-3 listed as user-selectable input commands 540. For example, one of the input commands 540 is the condition that no call-center agent has accessed the opportunity document after the future time was entered. If a customer contacts the call center, an agent presumably would access the opportunity document, meaning that the condition is no longer satisfied. If, in contrast, no call-center agent accesses the document 500 before the specified future time, the document will be archived at the future time. If, on the other hand, the user does access the opportunity document in the meantime, the predefined action will not be automatically taken at the future time. Upon such a subsequent access, the user may again specify a future time for taking a predefined action.

Any of the examples described herein may be provided with the feature of specifying a condition for taking the predefined action. That is, a scheduled predefined action is not necessarily taken at the specified future time, but may depend on whether a condition has been specified and on whether the condition is met upon evaluation. Different conditions than the one described above may be used. Also, more than one condition and/or an action scheduled in various combinations may be used for a document.

The predefined action to be automatically taken may be of many different kinds. For example, the predefined action may involve relocating the document, deleting the document, archiving the document, changing a status of the document, changing a classification of the document, initiating a workflow in the system 100 with regard to the document, and combinations thereof.

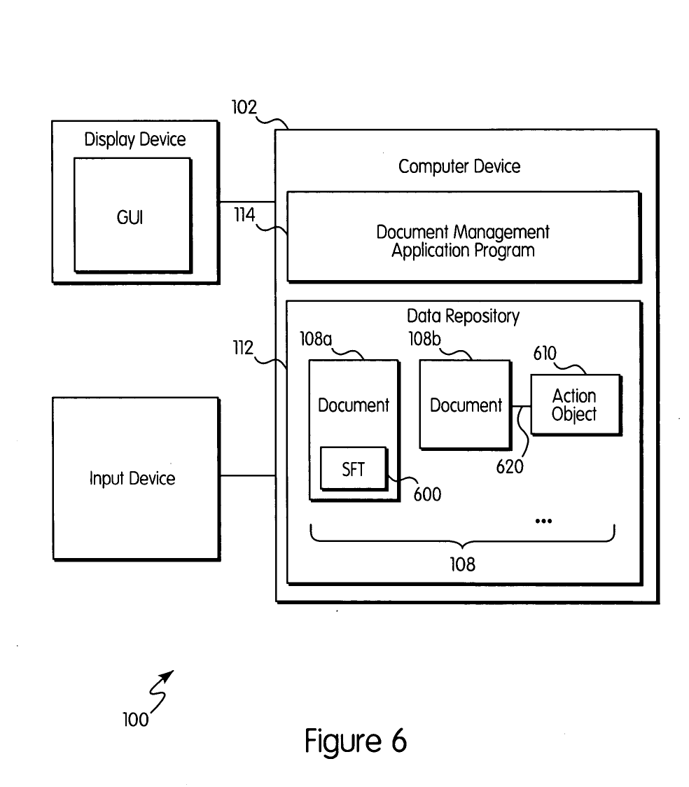

FIG. 6 shows examples of how the computer system 100 can record the specified future time. Recording the specified future time may involve adding specific data to the document. For example, a specific future time (SFT) is added to an exemplary document 108A that is stored in the data repository 112. The SFT 600 may be a time stamp or equivalent form of data that the system 100 interprets as a specified time. From time to time, or at regularly scheduled intervals, the system 100 may review any SPFs 600 that are included in documents stored in the data repository 112 and take the predefined action with regard to those documents where it is due. For example, the document management application program 114 may perform this review and may initiate the corresponding action(s).

As another example, recording the specified future time may involve associating an action object with the document. Here, an action object 610 has been associated with an exemplary document 108B through an association 620. The action object is configured such that it will cause the system 100 to automatically take the predefined action at the specified future time. For example, the action object 610 can be generated by the document management application program 114. The action object can be associated with more than one object by creating several associations 620, wherein the predefined action is performed for all of the objects at the future time, subject perhaps to any specified conditions.

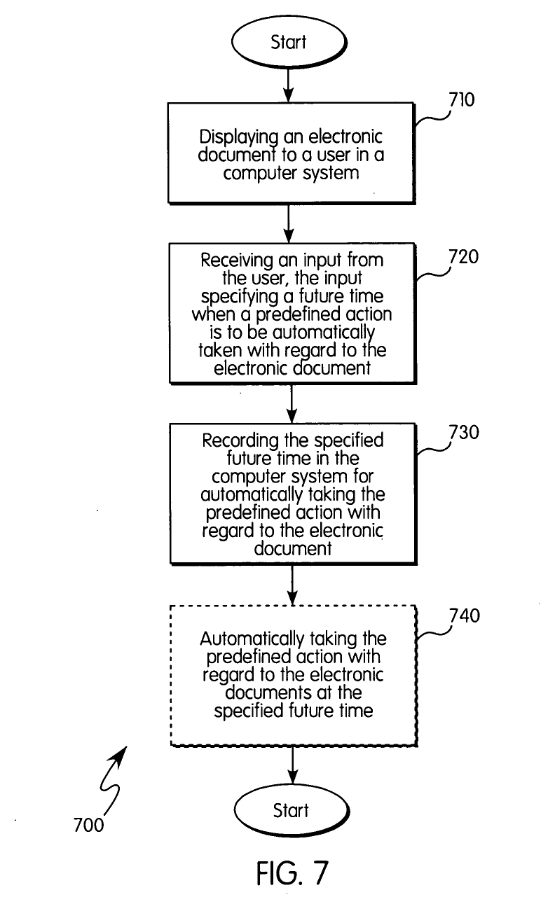

FIG. 7 is a flow chart of a method 700. The method 700 may be performed in the system 100. For example, a computer program product may include instructions that cause a processor to perform operations comprising the steps of the method. As shown in FIG. 7, the method 700 includes the following steps:

Displaying, in step 710, an electronic document to a user in a computer system. For example, the computer device 102 may display any of the documents 108 in the GUI 110 on the display device 114.

Receiving, in step 720, an input from the user, the input specifying a future time when a predefined action is to be automatically taken with regard to the electronic document. For example, the user may make the input with the input control 210, with one of the input controls 360, by placing the document in one of the folders 400, or using one of the input controls 520 and 530. For example, the specified future time may be a fix date and time in the future.

Recording, in step 730, the specified future time in the computer system for automatically taking the predefined action with regard to the electronic document. For example, the SFT 600 may be added to the document 108A, or the action object 610 may be associated with the document 108B.

Automatically taking, in optional step 740, the predefined action with regard to the electronic document at the specified future time. For example, if no condition has been specified, the computer device 102 takes the predefined action at the specified future time. As another example, if a condition has been specified and the condition is not satisfied, the computer device 102 does not take the predefined action at the specified future time.

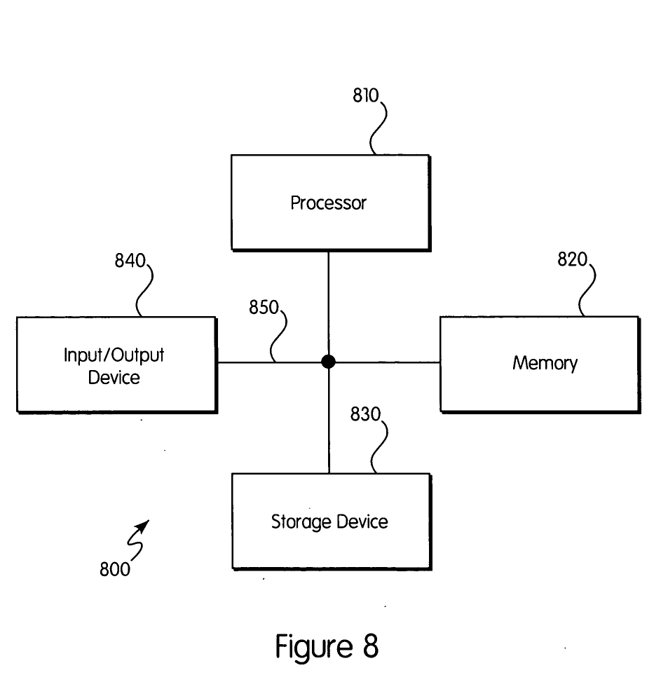

FIG. 8 is a block diagram of a computer system 800 that can be used in the operations described above, according to one embodiment. For example, the system 800 may be included in the system 100.

The system 800 includes a processor 810, a memory 820, a storage device 830 and an input/output device 840. Each of the components 810, 820, 830 and 840 are interconnected using a system bus 850. The processor 810 is capable of processing instructions for execution within the system 800. In one embodiment, the processor 810 is a single-threaded processor. In another embodiment, the processor 810 is a multi-threaded processor. The processor 810 is capable of processing instructions stored in the memory 820 or on the storage device 830 to display graphical information for a user interface on the input/output device 840.

The memory 820 stores information within the system 800. In one embodiment, the memory 820 is a computer-readable medium. In one embodiment, the memory 820 is a volatile memory unit. In another embodiment, the memory 820 is a non-volatile memory unit.

The storage device 830 is capable of providing mass storage for the system 800. In one embodiment, the storage device 830 is a computer-readable medium. In various different embodiments, the storage device 830 may be a floppy disk device, a hard disk device, an optical disk device, or a tape device.

The input/output device 840 provides input/output operations for the system 800. In one embodiment, the input/output device 840 includes a keyboard and/or pointing device. In one embodiment, the input/output device 840 includes a display unit for displaying graphical user interfaces.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A method of reducing a user's work load relating to managing an electronic document, the method comprising:
displaying an electronic document to a user in a computer system;
receiving an input from the user, the input specifying a future time when a predefined action is to be automatically taken with regard to the electronic document; and
recording the specified future time in the computer system for automatically taking the predefined action with regard to the electronic document.

2. The method of claim 1, wherein the user makes the input after the electronic document has been created.

3. The method of claim 2, wherein the input is made using an input control that is displayed in association with the electronic document.

4. The method of claim 1, wherein the future time is associated with a folder in the computer system and wherein the user makes the input by placing the electronic document in the folder.

5. The method of claim 4, wherein also the predefined action is associated with the folder.

6. The method of claim 1, wherein the specified future time is associated with a user-selectable input control for initiating creation of the electronic document.

7. The method of claim 6, wherein the computer system includes several alternative input controls for initiating the creation of the electronic document, each of the several input controls being associated with a different future time, and wherein upon user selection of one of the several alternative input controls the future time associated with the selected input control is recorded for automatically taking the predefined action with regard to the electronic document.

8. The method of claim 6, wherein also the predefined action is associated with the user-selectable input control.

9. The method of claim 1, wherein the specified future time is one selected from the group consisting of: a fix future time, a specific future time measured from a time of receiving the input, a specific future time measured from a time of creating the electronic document, an event in the computer system, and combinations thereof.

10. The method of claim 1, wherein the predefined action to be automatically taken with regard to the electronic document is one selected from the group consisting of: relocating, deleting, archiving, changing status, changing classification, initiating a workflow with regard to the electronic document, and combinations thereof.

11. The method of claim 1, further comprising automatically taking the predefined action with regard to the electronic document at the specified future time.

12. The method of claim 11, wherein the computer system also includes a default rule specifying a default time for automatically taking the predefined action.

13. The method of claim 1, wherein the input further specifies a condition for automatically taking the predefined action with regard to the electronic document at the specified future time.

14. The method of claim 13, further comprising automatically taking the predefined action with regard to the electronic document at the specified future time if the condition is satisfied.

15. The method of claim 13, wherein the condition is that no one has accessed the electronic document after the specified future time was recorded.

16. The method of claim 1, wherein the computer system includes an action object for automatically taking the predefined action, and wherein the specified future time is recorded in association with the action object.

17. The method of claim 16, wherein the action object is stored in association with the electronic object.

18. The method of claim 16, further comprising evaluating the action object and automatically taking the predefined action at the specified future time.

19. The method of claim 1, wherein the specified future time is recorded by adding specific data to the electronic document.

20. The method of claim 19, further comprising reading the specific data in the electronic document and automatically taking the predefined action at the specified future time.

21. A computer program product tangibly embodied in an information carrier, the computer program product including instructions that, when executed, cause a processor to perform operations comprising:
display an electronic document to a user in a computer system;
receive an input from the user, the input specifying a future time when a predefined action is to be automatically taken with regard to the electronic document; and
record the specified future time in the computer system for automatically taking the predefined action with regard to the electronic document.

22. The computer program product of claim 21, wherein the operations further comprise: display an input control in association with the electronic document, wherein the input is made using the input control.

23. The computer program product of claim 21, wherein the operations further comprise: generate a file folder in the computer system with which the future time is associated, wherein the user makes the input by placing the electronic document in the file folder.

24. The computer program product of claim 21, wherein the operations further comprise: display a user-selectable input control for initiating creation of the electronic document, wherein the specified future time is associated with the user-selectable input control.

25. The computer program product of claim 21, wherein the operations further comprise: take the predefined action with regard to the electronic document at the specified future time if a condition is satisfied, the condition being specified in the input.
